(19) United States
(12) Patent Application Publication
(10) Pub. No.: US 2009/0137432 A1
(43) Pub. Date: May 28, 2009

(54) pH Sensitive Emulsion System

(76) Inventors: Philp F. Sullivan, Bellaire, TX (US); Gary John Tustin, Cambridgeshire (GB)

Correspondence Address: SCHLUMBERGER TECHNOLOGY CORPORATION;David Cate, IP DEPT., WELL STIMULATION, 110 SCHLUMBERGER DRIVE, MD1, SUGAR LAND, TX, 77478, US

(21) Appl. No.: 11/946,412

(22) Filed: Nov. 28, 2007

(51) Int. Cl. C09K 8/588

(52) U.S. Cl. 507/219

(57) ABSTRACT

An oilfield treatment fluid in the form of an emulsion wherein the emulsion contains at least one treatment agent sequestered within a phase of the emulsion, wherein the emulsion is stable when the pH is maintained within a predetermined range, and breaks to release the at least one treatment agent when the pH is changed to a release pH value outside the predetermined stable pH range.

### FIELD OF THE INVENTION

The invention relates to oilfield treatment fluids and methods for their use. Specifically, the invention relates to pH sensitive emulsions and their methods of use for controlled release treatments in subterranean formations.

### BACKGROUND OF THE INVENTION

The statements in this section merely provide background information related to the present disclosure and may not constitute prior art.

Hydrocarbon fluids, such as oil and natural gas, and other desirable formation fluids are obtained from a subterranean geologic formation, i.e., a reservoir, by drilling a well that penetrates the formation zone that contains the desired fluid Once a wellbore has been drilled, the well must be completed. A well “completion” involves the design, selection, and installation of equipment and materials in or around the wellbore for conveying, pumping, or controlling the production or injection of fluids. After the well has been completed, production of the formation fluids can begin. During production, the well may require stimulation to improve flow of the oil through the formation to increase the well production, and if production declines, the well may need “work over” treatments to see if production can be returned to a productive state.

Various treatment fluids are used at these different stages of the life of the well. The fluids must be placed in the well at the time in which the agents in the fluids are needed. This can be inconvenient, and can result in multiple treatments and treatment steps in order to place certain agents in the well at the right timing for those agents to have the desired effect.

Further, agents can be degraded before reaching the site at which the agent is to have its effect. Or they can react with other agents present in the fluid or in the formation and be neutralized or otherwise rendered unavailable, such as by having other agents bond to the active sites on the agent.

Different types of methodologies have been employed to try to delay or control the release and subsequent action of the agent(s), so that they may be placed in the wellbore at more convenient times, or in order to keep agents isolated from other chemicals or agents until reaching the treatment site. Such methodologies include encapsulation and the like, which can be effective for solid agents, but which are frequently not practical for use with liquid agents and which can be expensive to produce, negating or reducing the benefit of efficiency improvement.

It would be useful to have another means of controlled release, especially of liquid agents. Furthermore, improved radial penetration of the formation is desirable with some treatment fluids. In certain instances, chemical or biological agents that would normally react in the immediate vicinity of the well bore, may be sequestered for a time in an emulsion, allowing them to travel further radially through the formation before reacting.

It has now been discovered that an emulsion can be formed which is designed to isolate an agent within the emulsion and then provide controlled release of the agent. The emulsion break is triggered by pH level; thus, at certain pH values the emulsion is stable for an indefinite period of time, but change in pH will break the emulsion, thus releasing the sequestered agents into the formation.

### SUMMARY OF THE INVENTION

The invention provides a treatment fluid in the form of an emulsion wherein the emulsion contains at least one treatment agent sequestered within a phase of the emulsion, wherein the emulsion is stable when the pH is maintained within a predetermined range.

The invention also provides an oilfield treatment system comprising an emulsion comprising at least one treatment agent wherein such agent remains sequestered in the emulsion until release is triggered by a change in the pH. Such change can be a drop in pH or a rise in pH, depending on the specific emulsion.

In one embodiment, the invention provides a method of treatment of a subterranean formation penetrated by a wellbore comprising the use of an emulsion containing at least one agent which will remain sequestered in the emulsion until the emulsion is broken.

In one embodiment, the method of treatment comprises an emulsion having an aqueous phase, and an oil phase.

In other embodiments, the emulsion can be an oil-in-water emulsion or a water-in-oil emulsion. In water-in-oil emulsions, useful ratios of oil to water include the range of from about 30/70 to about 60/40, including all intervening ratios such as 30/70; 40/60; 50/50, 60/40, 61/39, and the like.

In one embodiment, the emulsion includes a cleavable surfactant which hydrolyzes when the pH is changed to a value outside a predetermined stability range.

In one embodiment, the emulsion contains an oleic acid surfactant in one phase.

In another embodiment, the emulsion contains small particles of acid, i.e., the emulsion is a Pickering emulsion.

All parts, ratios and percentages herein are by weight unless otherwise specifically noted.

### DETAILED DESCRIPTION OF THE INVENTION

At the outset, it should be noted that in the development of any such actual embodiment, numerous implementation-specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. The description and examples are presented solely for the purpose of illustrating the preferred embodiments of the invention and should not be construed as a limitation to the scope and applicability of the invention. While the compositions of the present invention are described herein as comprising certain materials, it should be understood that the composition could optionally comprise two or more chemically different materials. In addition, the composition can also comprise some components other than the ones already cited. In the summary of the invention and this detailed description, each numerical value should be read once as modified by the term “about” (unless already expressly so modified), and then read again as not so modified unless otherwise indicated in context. Also, in the summary of the invention and this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possession of the entire range and all points within the range.

This invention relates to fluids used in treating a subterranean formation, and in particular, the invention relates to the use of water-in-oil emulsions and water-in-water emulsions useful for creating wellbore fluids which sequester treatment agents, and in methods of treating subterranean formations with such emulsions.

“Water-in-water emulsion”, as used herein refers to the situation when two or more different water soluble polymers are dissolved together in an aqueous medium, and the system phase separates into distinct regions. For example, this happens when two polymers are chosen that are each water-soluble but thermodynamically incompatible with each other. Such two-phase systems are referred to as “water-in-water emulsions” in some literature, and ATPS (Aqueous Two Phase Systems) in other literature. In the food industry, such fluids are used to create polymer solutions that mimic the properties of fat globules. Although they may be referred to as “emulsions” they do not necessarily contain either oil or surfactant. In the biomedical industry, such systems are exploited as separation media for proteins, enzymes, and other macromolecules that preferentially partition to one polymer phase in the mixture.

Some embodiments of the invention are based upon such two-phase polymer-polymer systems achievable with polymers of interest to the oilfield.

The agent to be sequestered may be any useful oilfield treatment agent, including but not limited to crosslinkers, polymers, biocides, corrosion inhibitors, corrosion dissolvers, pH modifiers, breakers, metal chelators, metal complexors, antioxidants, wetting agents, polymer stabilizers, clay stabilizers, scale inhibitors, scale dissolvers, wax inhibitors, wax dissolvers, asphaltene precipitation inhibitors, waterflow inhibitors, sand consolidation chemicals, permeability modifiers, foaming agents, microorganisms, nutrients for microorganisms, and salts.

In one embodiment, the emulsion of the invention is a microemulsion (e.g., the droplets of the discontinuous phase are typically about 0.5 to 200 nm in diameter). In the absence of destabilizing conditions, such as those listed above, microemulsions tend to be relatively more stable than macroemulsions, which often spontaneously separate into two continuous layers with time. Thus microemulsions are better suited to offsite preparation and to storage for a time prior to use (i.e., they can have an improved shelf life). Furthermore, microemulsions frequently have lower viscosities than macroemulsions, making them easier to pump into a well bore to a hydrocarbon-bearing formation. Small droplet size, as is seen in microemulsions, can be advantageous for achieving good penetration of the formation by the discontinuous phase. While the preparation of a macroemulsion often requires a large energy input to achieve high shear mixing, in contrast, microemulsions can often be prepared by a gentle stirring or shaking action.

The emulsions of the present invention are typically stabilized by at least one surfactant for stabilization. Surfactants (e.g., surface active compounds) are amphiphilic molecules or ions, made up of a hydrophobic and a hydrophilic part. There are four main classes of surfactants, namely anionic, cationic, and zwitterionic, based on the nature of the surfactant's hydrophilic part or head group. The hydrophobic portion of a surfactant is referred to as its tail. In compositions of the present invention, it is preferred that most of the stabilizing surfactant be located at the interface between the discontinuous and continuous phase. It should be noted that “stabilizing surfactant” as used in the present application refers to a surface active compound that stabilizes the emulsion.

Exposure to a change in pH destabilizes the emulsions used in the present invention. A change in pH of a stabilizing surfactant's environment can cause a decrease in the solubility of the stabilizing surfactant or can change its chemical properties such that its ability to act as a stabilizing surfactant is impaired (e.g., the hydrolysis of certain surfactants is greatly accelerated in the presence of hot acids or hot alkali). Thus, the difference in pH used in destabilizing an emulsion can be due to introduction of pH modifier into the fluid composition after it is pumped into a well. For example, there can be a pre-existing difference in pH between a first zone and a second zone, wherein at least one pH modifier is present in the second zone at a higher concentration than it is in the first zone. The higher pH modifier concentration in the second zone can be naturally occurring or can be the result of manipulation (e.g., pH modifier delivered to the second zone or components that react to produce pH modifier delivered to the second zone).

Alternatively, such a change in pH that results in destabilization of the emulsion can be the result of at least one of a slowly generated pH modifier (e.g., an acid or a base) resulting from a chemical reaction of one or more components already present in the fluid composition when the fluid composition is pumped into the well bore, an interaction between components of the well treatment fluid and materials present in the well, or a slow dissolution of one or more components already present in the fluid composition when the fluid composition is pumped into the well. For example, magnesium oxide included in certain fluid compositions could be solubilized slowly to change the pH of the composition. In certain embodiments of the present invention, it is preferred that the pH modifier be a base. For example, crosslinking by a borate of certain polymers (e.g., guar polymers) occurs at an alkaline pH.

Examples of alkaline pH modifiers that can be used to cause emulsion destabilization include alkali metal hydroxides, oxides, phosphates, carbonates and bicarbonates; alkaline earth oxides, phosphates, and carbonates; ammonium hydroxide, ammonium carbonate, and ammonium bicarbonate; alkali metal silicates, and base precursors such as ureas and substituted ureas, cyanates, alkylamines and certain alkanolamines, quaternary ammonium salts, ammonium salts and salts of a weak acid and a strong base, among others.

Exemplary acidic pH modifiers include inorganic acids such as hydrochloric or hydrofluoric acid; organic acids such as citric, acetic, formic acid; and acid precursors such as hydrolyzable esters, acid anhydrides, sulfonates, organic halides, and salts of a strong acid and a weak base, among others. Preferred acid-producing chemical reactions that can be used to advantage in the present invention include those that rely on hydrolyzable esters as precursors. Esters can be hydrolyzed to form acid and alcohol. Exemplary esters include methyl, ethyl and propyl formates; methyl, ethyl and propyl acetates; dimethyl- or diethyl-oxalate, malonate, succinate, glutarate, adipate, pimelate, maleate and fumarate, among others. Preferred base-producing chemical reactions that can be used to destabilize the emulsion include those that rely on ureas and cyanates. Exemplary bases include urea, thiourea, methyl and ethyl ureas, dimethyl and diethyl ureas; tetramethyl urea, and sodium cyanate, among others. Thus, certain fluid compositions of the present invention can comprise acid or base precursors that are added to the fluid composition just prior to the composition being pumped into the well bore, where they subsequently undergo chemical reaction to produce pH modifiers that destabilize the emulsion. Preferably, the chemical reaction does not go to completion before the chemical or biological agent is to be released. If added too early, reactions of such materials could result in premature destabilization of the emulsion.

Examples of pH sensitive surfactants that can be employed in the present invention as stabilizing surfactants include all classes of surfactants. Suitable stabilizing surfactants that are sensitive to pH change include ether alcohol sulfates, alkyl sulfates, carboxylic acid salts (e.g., sodium stearate), alkyl aryl sulfonates and sulfonic acids, petroleum sulfonates, alpha olefin sulfonates, sorbitan monolaurate, sorbitan trioleate, oleic acid, sorbitan monopalmitate, sorbitan tristearate, and cocamidopropyl betaine, among others.

A single stabilizing surfactant or a mixture of stabilizing surfactants can be used to stabilize the emulsion. The emulsion stabilizing surfactant used in certain embodiments depends in part on the destabilizing condition that is to be used and on conditions in the environment in which the composition is to be used. In certain embodiments, the destabilization of the emulsion is achieved by reducing the effectiveness of the stabilizing surfactant, or by reducing the stabilizing surfactant concentration at the interface between the discontinuous phase and the continuous phase.

Mixtures of similar stabilizing surfactants belonging to the same class or mixtures of stabilizing surfactants from different classes can be employed in preparing emulsions and microemulsions. Mixtures of similarly structured stabilizing surfactants are preferred, because they are generally less expensive, since certain such mixtures are routinely produced in the course of manufacturing a particular surfactant in which the feedstock used is impure. These mixtures can offer advantages over their pure counterparts by extending the useful range in which emulsions are formed and remain stable. Certain mixtures of stabilizing surfactants from different classes, such as combinations of nonionic and cationic surfactants or of anionic and cationic surfactants, can have synergistic effects that can be used to prepare emulsions. In contrast, non-preferred mixtures of surfactants from different classes can result in interaction between the different types of surfactants that neutralizes their surfactant characteristics (e.g., a stabilizing surfactant/destabilizing surfactant relationship), diminishing the ability of the stabilizing surfactant to stabilize an emulsion.

A preferred embodiment of the invention is the use of a fluid emulsion containing a surfactant which is a viscoelastic surfactant selected from zwitterionic, amphoteric, and cationic surfactants and mixtures of those surfactants, and a rheology enhancer in a concentration sufficient to shorten the shear recovery time of the fluid, in which the rheology enhancer is selected from the group consisting of an amphiphilic polymer, for example a homopolymer or copolymer containing at least a portion consisting of partially hydrolyzed polyvinyl ester or partially hydrolyzed polyacrylate or sulfonate-containing polymers. The rheology enhancer may also increase the viscosity of the fluid.

In a more preferred embodiment the viscoelastic surfactant system may contain a zwitterionic surfactant, for example a surfactant or mixture of surfactants having the formula:

RCONH—(CH₂)ₐ(CH₂CH₂O)ₘ(CH₂)_{b}—N⁺(CH₃)₂—(CH₂)_{a′}(CH₂CH₂O)_{m′}(CH₂)_{b′}COO—

in which R is an alkyl group that contains from about 17 to about 23 carbon atoms which may be branched or straight chained and which may be saturated or unsaturated; a, b, a′, and b′ are each from 0 to 10 and m and m′ are each from 0 to 13, a and b are each 1 or 2 if m is not 0 and (a+b) is from 2 to 10 if m is 0; a′ and b′ are each 1 or 2 when m′ is not 0 and (a′+b′) is from 1 to 5 if m′ is 0; (m+m′) is from 0 to 14; and CH₂CH₂O may also be OCH₂CH₂.

The zwitterionic surfactant may have the betaine structure:

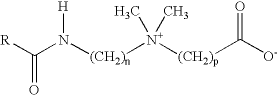

in which R is a hydrocarbyl group that may be branched or straight chained, aromatic, aliphatic or olefinic and has from about 14 to about 26 carbon atoms and may contain an amine; n=about 2 to about 4; and p=1 to about 5, and mixtures of these compounds. The betaine may be oleylamidopropyl betaine or erucylamidopropyl betaine and may contain a co-surfactant.

The viscoelastic surfactant system may contain a cationic surfactant, for example a surfactant or mixture of surfactants having the structure:

R₁N⁺(R₂)(R₃)(R₄)X⁻

in which R₁ has from about 14 to about 26 carbon atoms and may be branched or straight chained, aromatic, saturated or unsaturated, and may comprise a carbonyl, an amide, a retroamide, an imide, a urea, or an amine; at least one of R₂, R₃, and R₄ is hydrogen, the others two are independently hydrogen or a C₁ to about C₆ aliphatic group which may be the same or different, branched or straight chained, saturated or unsaturated and one or more than one of which may be substituted with a group that renders the R₂, R₃, and R₄ group more hydrophilic; the R₂, R₃ and R₄ groups may be incorporated into a heterocyclic 5- or 6-member ring structure which includes the nitrogen atom; the R₂, R₃ and R₄ groups may be the same or different; R₁, R₂, R₃ and/or R₄ may contain one or more ethylene oxide and/or propylene oxide units; and X⁻ is an anion; and mixtures of these compounds. As a further example, R₁ contains from about 18 to about 22 carbon atoms and may contain a carbonyl, an amide, or an amine; R₂, R₃, and R₄ contain from 1 to about 3 carbon atoms, and X⁻ is a halide. As a further example, R₁ comprises from about 18 to about 22 carbon atoms and may comprise a carbonyl, an amide, or an amine, and R₂, R₃, and are the same as one another and comprise from 1 to about 3 carbon atoms. The cationic viscoelastic surfactant system optionally contains amines, alcohols, glycols, organic salts, chelating agents, solvents, mutual solvents, organic acids, organic acid salts, inorganic salts, oligomers, polymers, co-polymers, and mixtures of said materials, present at a concentration of between about 0.01 and about 10 percent, for example at a concentration of between about 0.01 and about 1 percent. The amphoteric surfactant may be, for example, an amine oxide, for example an amidoamine oxide.

The fluid can further contain a rheology enhancer. Such rheology enhancer can be present in the fluid at a concentration of from about 0.0005% to about 0.2%, for example at a concentration of from about 0.001% to about 0.05%. The rheology enhancer contains, as one example, a partially hydrolyzed polyvinyl acetate having a percent hydrolysis between about 10% and about 95%. The molecular weight is, for example, from about 500 to about 100,000,000. Other esters may be used, for example C₂ to C₅ esters (i.e. the partially hydrolyzed ethyl to pentyl esters of polyvinyl alcohol). As another example, the rheology enhancer contains partially hydrolyzed polyvinyl acetate having a percent hydrolysis between about 30% and about 88%, and the molecular weight is, for example, from about 500 to about 1,000,000,000.

The rheology enhancer may also contain partially hydrolyzed polyacrylates, or partially hydrolyzed polymethacrylates or the like, for example, but not limited to, partially hydrolyzed polymethyl acrylate, partially hydrolyzed polyethyl acrylate, partially hydrolyzed polybutyl acrylate, partially hydrolyzed polymethyl methacrylate, and mixtures of these polymers. The rheology enhancer may also contain sulfonate-containing polymers.

The amphiphilic polymer or copolymer rheology enhancer may be linear, branched, or have a comb, dendritic, brush, graft, star or star-branched shape. It may contain repeating units other than vinyl esters, vinyl acrylates, and the corresponding hydrolyzed groups. The other repeating units are, for example, polyethylene oxide/polyethylene glycol or polypropylene oxide/polypropylene glycol. The copolymers may be random, alternating, or block copolymers.

In some embodiments, the fluids used may further include a crosslinker. Adding crosslinkers to the fluid may further augment the viscosity of the fluid. Crosslinking consists of the attachment of two polymeric chains through the chemical association of such chains to a common element or chemical group. Suitable crosslinkers may comprise a chemical compound containing a polyvalent metal ion such as, but not necessarily limited to, chromium, iron, boron, aluminum, titanium, antimony and zirconium.

Breakers may optionally be used in some embodiments of the invention. The purpose of this component is to “break” or diminish the viscosity of the fluid so that this fluid is even more easily recovered from the formation during cleanup. With regard to breaking down viscosity, oxidizers, enzymes, or acids may be used. Breakers reduce the polymer's molecular weight by the action of an acid, an oxidizer, an enzyme, or some combination of these on the polymer itself. In the case of borate-crosslinked gels, increasing the pH and therefore increasing the effective concentration of the active crosslinker (the borate anion), will allow the polymer to be crosslinked. Lowering the pH can just as easily eliminate the borate/polymer bonds. At pH values at or above 8, the borate ion exists and is available to crosslink and cause gelling. At lower pH, the borate is tied up by hydrogen and is not available for crosslinking, thus gelation caused by borate ion is reversible. Preferred breakers include 0.1 to 20 pounds per thousands gallons of conventional oxidizers such as ammonium persulfates, live or encapsulated, or potassium periodate, calcium peroxide, chlorites, and the like. In oil producing formations the film may be at least partially broken when contacted with formation fluids (oil), which may help de-stabilize the film.

A fiber component may be included in the fluids used in the invention to achieve a variety of properties including improving particle suspension, and particle transport capabilities, and gas phase stability. Fibers used may be hydrophilic or hydrophobic in nature, but hydrophilic fibers are preferred. Fibers can be any fibrous material, such as, but not necessarily limited to, natural organic fibers, comminuted plant materials, synthetic polymer fibers (by non-limiting example polyester, polyaramide, polyamide, novoloid or a novoloid-type polymer), fibrillated synthetic organic fibers, ceramic fibers, inorganic fibers, metal fibers, metal filaments, carbon fibers, glass fibers, ceramic fibers, natural polymer fibers, and any mixtures thereof. Particularly useful fibers are polyester fibers coated to be highly hydrophilic, such as, but not limited to, DACRON® polyethylene terephthalate (PET) Fibers available from Invista Corp. Wichita, Kans., USA, 67220. Other examples of useful fibers include, but are not limited to, polylactic acid polyester fibers, polyglycolic acid polyester fibers, polyvinyl alcohol fibers, and the like.

When used in fluids of the invention, the fiber component may be included at concentrations from about 1 to about 15 grams per liter of the liquid phase of the fluid, preferably the concentration of fibers are from about 2 to about 12 grams per liter of liquid, and more preferably from about 2 to about 10 grams per liter of liquid.

Embodiments of the invention may use other additives and chemicals that are known to be commonly used in oilfield applications by those skilled in the art. These include, but are not necessarily limited to, materials in addition to those mentioned hereinabove, such as breaker aids, oxygen scavengers, alcohols, scale inhibitors, corrosion inhibitors, fluid-loss additives, bactericides, iron control agents, organic solvents, and the like. Also, they may include a co-surfactant to optimize viscosity or to minimize the formation of stabilized emulsions that contain components of crude oil, or as described hereinabove, a polysaccharide or chemically modified polysaccharide, natural polymers and derivatives of natural polymers, such as cellulose, derivatized cellulose, guar gum, derivatized guar gum, or biopolymers such as xanthan, diutan, and scleroglucan, synthetic polymers such as polyacrylamides and polyacrylamide copolymers, oxidizers such as persulfates, peroxides, bromates, chlorates, chlorites, periodates, and the like. Some examples of organic solvents include ethylene glycol monobutyl ether, isopropyl alcohol, methanol, glycerol, ethylene glycol, mineral oil, mineral oil without substantial aromatic content, and the like.

Embodiments of the invention may also include placing proppant particles that are substantially insoluble in the fluids. Proppant particles carried by the treatment fluid remain in the fracture created, thus propping open the fracture when the fracturing pressure is released and the well is put into production. Suitable proppant materials include, but are not limited to, sand, walnut shells, sintered bauxite, glass beads, ceramic materials, naturally occurring materials, or similar materials. Mixtures of proppants can be used as well. If sand is used, it will typically be from about 20 to about 100 U.S. Standard Mesh in size. Naturally occurring materials may be underived and/or unprocessed naturally occurring materials, as well as materials based on naturally occurring materials that have been processed and/or derived. Suitable examples of naturally occurring particulate materials for use as proppants include, but are not necessarily limited to: ground or crushed shells of nuts such as walnut, coconut, pecan, almond, ivory nut, brazil nut, etc.; ground or crushed seed shells (including fruit pits) of seeds of fruits such as plum, olive, peach, cherry, apricot, etc.; ground or crushed seed shells of other plants such as maize (e.g., corn cobs or corn kernels), etc.; processed wood materials such as those derived from woods such as oak, hickory, walnut, poplar, mahogany, etc. including such woods that have been processed by grinding, chipping, or other form of particalization, processing, etc. Further information on nuts and composition thereof may be found in Encyclopedia of Chemical Technology, Edited by Raymond E. Kirk and Donald F. Othmer, Third Edition, John Wiley & Sons, Volume 16, pages 248-273 (entitled “Nuts”), Copyright 1981, which is incorporated herein by reference.

The concentration of proppant in the fluid can be any concentration known in the art, and will preferably be in the range of from about 0.05 to about 3 kilograms of proppant added per liter of liquid phase. Also, any of the proppant particles can further be coated with a resin to potentially improve the strength, clustering ability, and flow back properties of the proppant.

Conventional propped hydraulic fracturing techniques, with appropriate adjustments if necessary, as will be apparent to those skilled in the art, are used in some methods of the invention. One preferred fracture stimulation treatment according to the present invention typically begins with a conventional pad stage to generate the fracture, followed by a sequence of stages in which a viscous carrier fluid transports proppant into the fracture as the fracture is propagated. Typically, in this sequence of stages the amount of propping agent is increased, normally stepwise. The pad and carrier fluid can be a fluid of adequate viscosity. The pad and carrier fluids may contain various additives. Non-limiting examples are fluid loss additives, crosslinking agents, clay control agents, breakers, iron control agents, and the like, provided that the additives do not affect the stability or action of the fluid.

The procedural techniques for pumping fracture stimulation fluids down a wellbore to fracture a subterranean formation are well known. The person that designs such fracturing treatments is the person of ordinary skill to whom this disclosure is directed. That person has available many useful tools to help design and implement the fracturing treatments, one of which is a computer program commonly referred to as a fracture simulation model (also known as fracture models, fracture simulators, and fracture placement models). Most if not all commercial service companies that provide fracturing services to the oilfield have one or more fracture simulation models that their treatment designers use. One commercial fracture simulation model that is widely used by several service companies is known as FracCADE™. This commercial computer program is a fracture design, prediction, and treatment-monitoring program designed by Schlumberger, Ltd. All of the various fracture simulation models use information available to the treatment designer concerning the formation to be treated and the various treatment fluids (and additives) in the calculations, and the program output is a pumping schedule that is used to pump the fracture stimulation fluids into the wellbore. The text “Reservoir Stimulation,” Third Edition, Edited by Michael J. Economides and Kenneth G. Nolte, Published by John Wiley & Sons, (2000), is an excellent reference book for fracturing and other well treatments; it discusses fracture simulation models in Chapter 5 (page 5-28) and the Appendix for Chapter 5 (page A-15), which are incorporated herein by reference.

In the fracturing treatment, fluids of the invention may be used in the pad treatment, the proppant stage, or both. The components of the liquid phase are preferably mixed on the surface. Alternatively, a the fluid may be prepared on the surface and pumped down tubing while the gas component could be pumped down the annular to mix down hole, or vice versa.

Yet another embodiment of the invention includes cleanup method. The term “cleanup” or “fracture cleanup” refers to the process of removing the fracture fluid (without the proppant) from the fracture and wellbore after the fracturing process has been completed. Techniques for promoting fracture cleanup traditionally involve reducing the viscosity of the fracture fluid as much as practical so that it will more readily flow back toward the wellbore. While breakers are typically used in cleanup, the fluids of the invention may be effective for use in cleanup operations, with or without a breaker.

In another embodiment, the invention relates to gravel packing a wellbore. A gravel packing fluid, it preferably comprises gravel or sand and other optional additives such as filter cake clean up reagents such as chelating agents referred to above or acids (e.g. hydrochloric, hydrofluoric, formic, acetic, citric acid) corrosion inhibitors, scale inhibitors, biocides, leak-off control agents, among others. For this application, suitable gravel or sand is typically having a mesh size between 8 and 70 U.S. Standard Sieve Series mesh.

The following examples are presented to illustrate the preparation and properties of energized aqueous fluids comprising heteropolysaccharides and a surfactant, and should not be construed to limit the scope of the invention, unless otherwise expressly indicated in the appended claims. All percentages, concentrations, ratios, parts, etc. are by weight unless otherwise noted or apparent from the context of their use.

The term “well” as used in this specification includes the surface site from which a well bore has been drilled to a hydrocarbon-bearing formation and the well bore itself, as well as the hydrocarbon-bearing formation that surrounds the well bore.

### EXAMPLES

### Example 1

Emulsion stabilized with oleic acid surfactant.

This experiment demonstrates the creation and activation of a pH sensitive emulsion. The experiment began with 100 ml of DI water, to which was added 5 ml diesel, followed by 3 ml of an oleic acid package from ClearFRAC® EF. The pH at this point was approximately 3, and no emulsion was formed. Caustic was then added to increase pH. At a pH of approximately 9, an emulsion began to form when the sample was gently shaken. With increasing pH, an opaque, pink emulsion was formed throughout the sample at approximately pH 13. One part of sample was separated and held at this condition. It remained stable for the entire monitored period of two weeks. The other portion of the sample was destabilized by adding two drops of 15% HCl to the emulsion. When the pH of the water phase was dropped to approximately 4, the emulsion rapidly broke with large oil droplets coming out of solution.

Both the original stable emulsion and the destabilized emulsion are shown in FIG. 1, illustrating the ability to make a pH sensitive emulsion. By using the pH sensitive emulsion, triggered release can be used for anything that is desirable to release from the oil phase of the emulsion. The oil itself can be an active ingredient released for dissolving oil-soluble particles or for breaking a VES fluid.

What is claimed is:

1. An oilfield treatment fluid in the form of an emulsion having at least two phases wherein the emulsion contains at least one treatment agent sequestered within a phase of the emulsion, wherein the emulsion is stable when the pH is maintained within a predetermined range, and breaks to release the at least one treatment agent when the pH is changed to a release value outside the predetermined range.

2. An oilfield treatment fluid according to claim 1 wherein the emulsion is a water-in-oil emulsion.

3. An oilfield treatment fluid according to claim 1 wherein the emulsion is a water-in-water emulsion.

4. An oilfield treatment fluid according to claim 1 wherein the emulsion is a micro emulsion.

5. An oilfield treatment fluid according to claim 1 wherein the emulsion is a Pickering emulsion.

6. An oilfield treatment fluid according to claim 1 wherein the release pH value is from about 2 to about 12.

7. An oilfield treatment fluid according to claim 1 wherein said agent is selected from the group consisting of crosslinkers, polymers, biocides, corrosion inhibitors, corrosion dissolvers, pH modifiers, breakers, metal chelators, metal complexors, antioxidants, wetting agents, polymer stabilizers, clay stabilizers, scale inhibitors, scale dissolvers, wax inhibitors, wax dissolvers, asphaltene precipitation inhibitors, waterflow inhibitors, sand consolidation chemicals, permeability modifiers, foaming agents, microorganisms, nutrients for microorganisms, and salts.

8. An oilfield treatment fluid according to claim 1 wherein said emulsion contains a stabilizing surfactant.

9. An oilfield treatment fluid according to claim 5 wherein said stabilizing surfactant is selected from the group consisting of anionic, zwitterionic and amphoteric surfactant.

10. An oilfield treatment fluid according to claim 6 wherein said surfactant is a viscoelastic surfactant.

11. A method of treating a subterranean formation penetrated by a wellbore comprising:
a) providing an emulsion having a predetermined range in which the emulsion is stable;
b) sequestering a treatment agent in one phase of the emulsion;
c) pumping the emulsion into the wellbore;
d) exposing the emulsion to a pH outside of the range in which the emulsion is stable, and
e) allowing the emulsion to break, releasing the treatment agent into the formation.

12. The method of claim 11 wherein the emulsion is a water-in-oil emulsion.

13. The method of claim 11 wherein the emulsion is a water-in-water emulsion.

14. The method of claim 11 wherein the emulsion is a microemulsion.

15. The method of claim 11 wherein the emulsion is a Pickering emulsion.

16. The method of claim 11 wherein said predetermined pH range is from about 2 to about 12.

17. The method of claim 11 wherein the sequestered agent is selected from the group consisting of crosslinkers, polymers, biocides, corrosion inhibitors, corrosion dissolvers, pH modifiers, breakers, metal chelators, metal complexors, antioxidants, wetting agents, polymer stabilizers, clay stabilizers, scale inhibitors, scale dissolvers, wax inhibitors, wax dissolvers, asphaltene precipitation inhibitors, waterflow inhibitors, sand consolidation chemicals, permeability modifiers, foaming agents, microorganisms, nutrients for microorganisms, and salts.

18. The method of claim 11 wherein said emulsion contains a stabilizing surfactant.

19. The method of claim 18 wherein said stabilizing surfactant is selected from the group consisting of anionic, zwitterionic and amphoteric surfactant.

20. An oilfield treatment fluid according to claim 19 wherein said surfactant is a viscoelastic surfactant.
